(19) United States
(12) Patent Application Publication
(10) Pub. No.: US 2022/0251901 A1
(43) Pub. Date: Aug. 11, 2022

(54) ROLLER TUBE FOR DRIVING COLOR-CHANGING SHADE

(71) Applicant: JEFF WH LI, IRVINE, CA (US)

(72) Inventor: JEFF WH LI, IRVINE, CA (US)

(21) Appl. No.: 17/171,051

(22) Filed: Feb. 9, 2021

(51) Int. Cl. E06B 9/42; G08C 17/02; G05B 15/02; E06B 9/68

(52) U.S. Cl. CPC E06B 9/42; G08C 17/02; E06B 2009/2417; E06B 9/68; G05B 15/02

(57) ABSTRACT

A roller tube for driving color-changing shade is provided, comprising: a shade body, a winding mechanism and a control device. An output shaft of the motor is drivingly connected with the roller, and one end of the shade body is fixedly arranged on the roller. A hollow cavity is provided on the roller, the control device and the motor are arranged in the hollow cavity, and the shade body is a flexible electrically controlled dimming film. A wireless receiving module wirelessly is provided on the control device, and the flexible electrically controlled dimming film is electrically connected to the control device. A wireless transmitting module wirelessly connected to the wireless receiving module is provided a remote controller. The remote controller transmits a control signal to the wireless receiving module through the wireless transmitting module, and the wireless receiving module receives and transmits the control signal to the control device.

### FIELD OF THE DISCLOSURE

The present disclosure relates to the technical field of electronically controlled dimming films, in particular to a roller tube for driving color-changing shade.

### BACKGROUND OF THE DISCLOSURE

The existing electronically controlled dimming film is usually used to paste on the glass and used for electric control to embody shading or adjust the intensity of the sunlight entering the room. Such a film is suitable for the whole single glass window, and the family needs to switch and move the glass window frequently. Therefore, it is not suitable for the home environment. As a result, a device that does not affect the light shielding or dimming effect of the electronically controlled dimming film regardless of whether the glass window is opened or not is to be studied.

### SUMMARY OF THE DISCLOSURE

The purpose of the present disclosure is to address the defects and deficiencies of the prior art to provide a roller tube for driving color-changing shades, which is convenient to use, easy to install, does not need to be pasted, and avoids the phenomenon of wrinkles and bubbles appearing when the flexible electronically controlled dimming film is pasted.

According to the purpose of the present disclosure, a roller tube for driving color-changing shade is provided, comprising: a shade body, a winding mechanism and a control device, wherein the winding mechanism comprises a base, a roller and a motor arranged on the base, an output shaft of the motor is drivingly connected with the roller, one end of the shade body is fixedly arranged on the roller, the control device is used to control the shade body to wind up to an end adjacent to the roller or to control the shade body to unfold to one end away from the roller, and wherein a hollow cavity is provided on the roller, the control device and the motor are arranged in the hollow cavity, the shade body is a flexible electrically controlled dimming film; wherein the flexible electrically controlled dimming film is electrically connected to the control device, a wireless receiving module is provided on the control device, the flexible electronically controlled dimming film is electrically connected to the control device and used to change color under the control of the control device; and wherein the roller tube for driving color-changing shade further comprises: a remote control on which a wireless transmitting module wirelessly connected to the wireless receiving module is provided, wherein the remote controller transmits a control signal to the wireless receiving module through the wireless transmitting module, the wireless receiving module receives and transmits the control signal to the control device, and the control device controls the motor and/or the flexible electronically controlled dimming film to work according to the control signal.

In a preferred embodiment, a battery electrically connected to the control device for supplying power to the control device, the motor and the flexible electronically controlled dimming film is further provide in the hollow cavity.

In a preferred embodiment, a protective cover is provided on an outer cover of the winding mechanism, and a space for the shade body to pass through is provided at a lower side of the protective cover.

In a preferred embodiment, a fixing rod is arranged on one end of the shade body away from the winding mechanism.

In a preferred embodiment, the wireless receiving module is a radio frequency receiving module, and the wireless transmitting module is a radio frequency transmitting module.

After adopting the above technical solution, the present disclosure has the following beneficial effects. The roller tube for driving color-changing shade is fixed and assembled above the window, and the user can control the color change of the flexible electronically controlled dimming film through a remote control or smart electronic device to change the intensity of the sunlight entering the room or control the work of the winding mechanism to drop the flexible electronically controlled dimming film, which is convenient to use, easy to install, does not need to be pasted, and avoids the phenomenon of wrinkles and bubbles appearing when the flexible electronically controlled dimming film is pasted.

### BRIEF DESCRIPTION OF THE DRAWINGS

In order to explain the embodiments of the present disclosure or the technical solutions in the prior art more clearly, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative labor.

FIG. 1 is a structural block diagram for controlling the shading intensity of the shade body of the present disclosure.

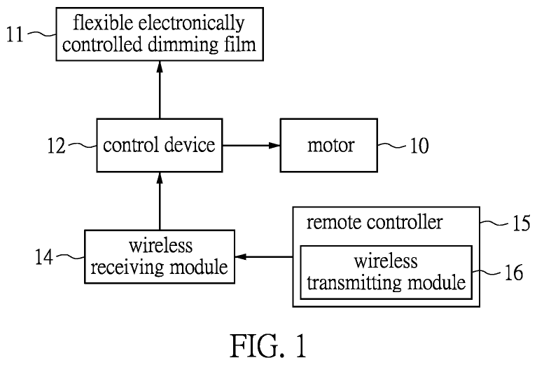

FIG. 2 is a schematic diagram of the falling structure of the shade body of the present disclosure.

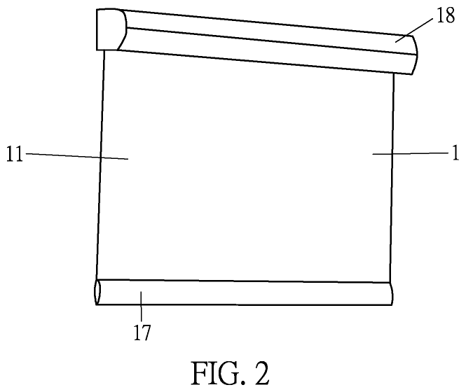

FIG. 3 is a schematic view of the retracted structure of the shade body of the present disclosure.

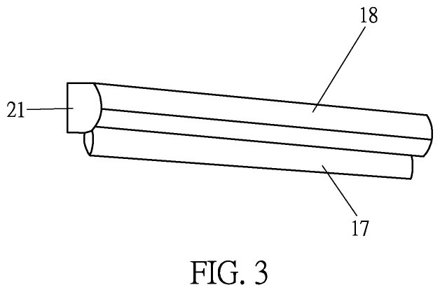

FIG. 4 is a schematic view of the present disclosure with the protective cover removed.

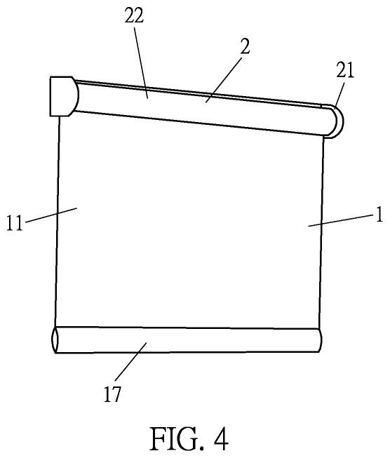

Reference numeral: 1. shade body; 2. winding mechanism; 11. flexible electrically controlled dimming film; 12. control device; 13. battery; 14. wireless receiving module; 15. remote control; 16. wireless transmitting module; 17. fixing rod; 18. protective cover; 21. base; 22. roller; 10. motor

### DETAILED DESCRIPTION OF THE EXEMPLARY EMBODIMENTS

The present disclosure will be further described in detail below in conjunction with the drawings.

This specific embodiment is only an explanation of the present disclosure, and it is not a limitation of the present disclosure. After reading this specification, those skilled in the art can make modifications that do not contribute to this embodiment as needed, but as long as they are within the scope of the claims of the present disclosure, they are protected by the patent law.

A roller tube for driving color-changing shade, comprising: a shade body 1, a winding mechanism 2 and a control device 12, wherein the winding mechanism 2 comprises a base 21, a roller 22 and a motor 10 arranged on the base 21, an output shaft of the motor 10 is drivingly connected with the roller 22, one end of the shade body 1 is fixedly arranged on the roller 22, the control device 12 is used to control the shade body 1 to wind up to an end adjacent to the roller 22 or to control the shade body 1 to unfold to one end away from the roller 22, and wherein a hollow cavity is provided on the roller 22, the control device 12 and the motor 10 are arranged in the hollow cavity, the shade body 1 is a flexible electrically controlled dimming film 11; wherein the flexible electrically controlled dimming film 11 is electrically connected to the control device 12, a wireless receiving module 14 is provided on the control device 12, the flexible electronically controlled dimming film 11 is electrically connected to the control device 12 and used to change color under the control of the control device 12; and wherein the roller tube for driving color-changing shade further comprises: a remote control 15 on which a wireless transmitting module 16 wirelessly connected to the wireless receiving module 14 is provided, wherein the remote controller 15 transmits a control signal to the wireless receiving module 14 through the wireless transmitting module 16, the wireless receiving module 14 receives and transmits the control signal to the control device 12, and the control device 12 controls the motor 10 and/or the flexible electronically controlled dimming film 11 to work according to the control signal. The flexible electronically controlled dimming film 11 is installed on the winding mechanism 2 to facilitate the user to adjust and control the degree of light transmission at any time. The use effect is good, the use is convenient, and it is convenient for the user to drop or roll the shade body 1 without damaging the shade body 1 during installation. There is no need to paste the shade body 1 on the glass of the window, even if the user opens the window, and the sunlight intensity of the room will not be affected. The flexible electronically controlled dimming film 11 is an NPD-LCD film in the prior art. The control device 12 is an integrated circuit board with a housing in the prior art.

Preferably, a battery 13 electrically connected to the control device 12 for supplying power to the control device 12, the motor 10 and the flexible electronically controlled dimming film 11 is further provide in the hollow cavity. The roller 22 is sleeved outside the motor 10. The motor 10, the control device 12, and the battery 13 are arranged in the roller 22, so that the roller tube for driving color-changing shade is more concise, occupies a small space, and is more beautiful. In this embodiment, the motor 10 is a servo motor 10 in the prior art. In this embodiment, the battery 13 is a rechargeable battery 13. In other embodiments, a fixing rod is provided on the side of the base 21 away from the motor 10, the fixing rod extends axially toward the roller 22, the fixing rod is located in the hollow cavity of the roller 22, and the control device 12 and the battery 13 are arranged on the fixing rod. It is avoided that the rotation of the roller 22 drives the rotation of the control device 12 and the battery 13 to cause the connection between the control device 12 and the motor 10 to be disconnected due to the rotation.

Preferably, a protective cover 18 is provided on an outer cover of the winding mechanism 2, and a space for the shade body 1 to pass through is provided at a lower side of the protective cover 18. Dust can be prevented from entering the winding mechanism 2. The shade body 1 is provided with a fixing rod 17 at one end away from the winding mechanism 2, and the size of the fixing rod 17 is larger than the size of the space. It is avoided that the roller 22 completely winds up the flexible electronically controlled dimming film 11 into the protective cover 18 and affects the laying down of the flexible electronically controlled dimming film 11. In some embodiments, a control device 12 the same as the control device 12 on the roller and battery can be arranged in the fixing rod 17, the control device 12 on the fixing rod 17 is electrically connected to the battery, and the flexible electronically controlled dimming film 11 is electrically connected with the control device 12 on the fixing rod 17 to control the color change of the flexible electronically controlled dimming film 11.

Preferably, the wireless receiving module 14 is a radio frequency receiving module, and the wireless transmitting module 16 is a radio frequency transmitting module. The radio frequency receiving module 14 is arranged on the control device 12 and is electrically connected to the control device 12; the radio frequency transmitting module 16 is arranged on the remote control 15 and is electrically connected to the circuit board in the remote control. In other embodiments, the wireless receiving module and the wireless transmitting module are Bluetooth communication modules matched with each other on the control device 12 and the remote control 15. Consequently, it is easy to use, and the user can control the color change of the flexible electronically controlled dimming film 11 and the start or stop of the motor 10 through the remote control 15 or a mobile phone equipped with a radio frequency wireless module. A remote control 15 can control the flexible electronically controlled dimming film 11 and the winding mechanism 2 to work.

The working principle of the present disclosure is roughly as follows. The roller tube for driving color-changing shade is fixed and assembled above the window, and the user can control the color change of the flexible electronically controlled dimming film 11 through the remote control 15 to change the intensity of the incoming sunlight or control the winding mechanism 2 to make the flexible electronically controlled dimming film 11 fall, which is convenient to use, easy to install, no need to paste, and to avoid the phenomenon of wrinkles and bubbles in the flexible electronically controlled dimming film 11 during the pasting process.

The above are only used to illustrate the technical solutions of the present disclosure and not to limit them. Other modifications or equivalent replacements made by those of ordinary skill in the art to the technical solution of the present disclosure shall be covered by the scope of the claims of the present disclosure as long as they do not depart from the spirit and scope of the technical solution of the present disclosure.

What is claimed is:

1. A roller tube for driving color-changing shade, comprising: a shade body (1), a winding mechanism (2) and a control device (12), wherein the winding mechanism (2) comprises a base (21), a roller (22) and a motor (10) arranged on the base (21), an output shaft of the motor (10) is drivingly connected with the roller (22), one end of the shade body (1) is fixedly arranged on the roller (22), the control device (12) is used to control the shade body (1) to wind up to an end adjacent to the roller (22) or to control the shade body (1) to unfold to one end away from the roller (22), and wherein a hollow cavity is provided on the roller (22), the control device (12) and the motor (10) are arranged in the hollow cavity, the shade body (1) is a flexible electrically controlled dimming film (11); wherein the flexible electrically controlled dimming film (11) is electrically connected to the control device (12), a wireless receiving module (14) is provided on the control device (12), and used to change color under the control of the control device (12); and wherein the roller tube for driving color-changing shade further comprises: a remote control (15) on which a wireless transmitting module (16) wirelessly connected to the wireless receiving module (14) is provided, wherein the remote controller (15) transmits a control signal to the wireless receiving module (14) through the wireless transmitting module (16), the wireless receiving module (14) receives and transmits the control signal to the control device (12), and the control device (12) controls the motor (10) and/or the flexible electronically controlled dimming film (11) to work according to the control signal.

2. The roller tube for driving color-changing shade according to claim 1, wherein a battery (13) electrically connected to the control device (12) for supplying power to the control device (12), the motor (10) and the flexible electronically controlled dimming film (11) is further provide in the hollow cavity.

3. The roller tube for driving color-changing shade according to claim 2, wherein a protective cover (18) is provided on an outer cover of the winding mechanism (2), and a space for the shade body (1) to pass through is provided at a lower side of the protective cover (18).

4. The roller tube for driving color-changing shade according to claim 3, wherein a fixing rod (17) is arranged on one end of the shade body (1) away from the winding mechanism (2).

5. The roller tube for driving color-changing shade according to claim 1, wherein the wireless receiving module (14) is a radio frequency receiving module and the wireless transmitting module (16) is a radio frequency transmitting module.
